(19) United States
(12) Patent Application Publication
(10) Pub. No.: US 2012/0061388 A1
(43) Pub. Date: Mar. 15, 2012

(54) Pipe and Pipe Joint Covering Apparatus

(75) Inventor: Pierre-Richard Jacques, Cape Coral, FL (US)

(73) Assignee: DEKORON UNITHERM LLC, Cape Coral, FL (US)

(21) Appl. No.: 13/231,422

(22) Filed: Sep. 13, 2011

Related U.S. Application Data
(60) Provisional application No. 61/382,580, filed on Sep. 14, 2010.

(51) Int. Cl. B65D 6/02; B28B 21/74; B23P 21/00

(52) U.S. Cl. 220/4.21; 29/469; 264/250

(57) ABSTRACT

A pipe covering apparatus and method associated therewith are provided. The apparatus includes a first half of the pipe covering apparatus mateable along a length with a second half of the pipe covering apparatus, wherein each of the first half and second half have a substantially rigid exterior shell and a flexible insulated liner positioned interior to the exterior shell. A plurality of male connecting elements and a plurality of female connecting elements are integral with each of the first half and second half. The plurality of male connecting elements and plurality of female connecting elements on the first half have identical positions to the plurality of male connecting elements and plurality of female connecting elements on the second half, wherein the plurality of male connecting elements on the first half engage with the plurality of female connecting elements on the second half.

### CROSS REFERENCE TO RELATED APPLICATION

This application claims benefit of U.S. Provisional Application Ser. No. 61/382,580 entitled, “Pipe And Pipe Joint Covering Apparatus” filed Sep. 14, 2010, the entire disclosure of which is incorporated herein by reference.

### FIELD OF THE DISCLOSURE

The present disclosure is generally related to pipe coverings and more particularly is related to pipe and pipe joint covering apparatus.

### BACKGROUND OF THE DISCLOSURE

A variety of pipes and piping systems are found within many industries, including the food processing industry, the biomedical industry and the pharmaceutical industry. The pipes and piping systems may transport various substances through processing, and are therefore important to a continuously successful operation. To protect the pipes and piping systems and increase thermal efficiency, a conventional single or two-piece thin-walled polymeric or metal covers may be fixed in place over the pipes and/or piping system using tapes and/or adhesives. Conventionally, these covers require an installer to first manually install thermal insulation to the pipe and/or piping system and temporarily secure it to the pipe and/or piping system. The installer then retains the cover over the insulation, which may include bonding the pre-installed insulation to the cover. This is a cumbersome process that is frequently inefficient, since multiple steps are needed to cover the pipe and/or piping system. In addition, an installer will need a variety of different covers and for the various sizes of pipes and pipe joints within the piping system, which increases the installation inefficiency even more.

Thus, a heretofore unaddressed need exists in the industry to address the aforementioned deficiencies and inadequacies.

### SUMMARY OF THE DISCLOSURE

Embodiments of the present disclosure provide a pipe covering apparatus. Briefly described, in architecture, one embodiment of the system, among others, can be implemented as follows. A pipe covering apparatus includes a first half of the pipe covering apparatus mateable along a length with a second half of the pipe covering apparatus, wherein each of the first half and second half have a substantially rigid exterior shell and a flexible insulated liner positioned interior to the exterior shell. A plurality of male connecting elements and a plurality of female connecting elements are integral with each of the first half and second half. The plurality of male connecting elements and plurality of female connecting elements on the first half have identical positions to the plurality of male connecting elements and plurality of female connecting elements on the second half, wherein the plurality of male connecting elements on the first half engage with the plurality of female connecting elements on the second half.

The present disclosure can also be viewed as providing method for constructing a pipe covering apparatus. In this regard, one embodiment of such a method, among others, can be broadly summarized by the following steps: forming a first half and a second half of the pipe covering apparatus from a moldable material, wherein the first half is mateable along a length with the second half, wherein each of the first half and second half have a plurality of male connecting elements and a plurality of female connecting elements integrally formed with each of the first half and second half, wherein the plurality of male connecting elements and plurality of female connecting elements on the first half having identical positions to the plurality of male connecting elements and plurality of female connecting elements on the second half, wherein the plurality of male connecting elements on the first half are engagable with the plurality of female connecting elements on the second half; curing the first half and second half to form a rigid shell of the first half and the second half; and positioning a flexible insulated liner interior to the rigid shell of the first half and the second half.

Embodiments of the present disclosure also provide methods of covering a pipe section with a pipe covering apparatus. In this regard, one embodiment of such a method, among others, can be broadly summarized by the following steps: forming a first half and a second half of the pipe covering apparatus from a moldable material, wherein the first half is mateable along a length with the second half, wherein each of the first half and second half have a plurality of male connecting elements and a plurality of female connecting elements integrally formed with each of the first half and second half, wherein the plurality of male connecting elements and plurality of female connecting elements on the first half having identical positions to the plurality of male connecting elements and plurality of female connecting elements on the second half, wherein the plurality of male connecting elements on the first half are engagable with the plurality of female connecting elements on the second half; curing the first half and second half to form a rigid first half and a rigid second half; positioning a flexible insulated liner interior to the rigid first half and rigid second half; positioning the rigid first half in opposition to the rigid second half about the pipe section, wherein the pipe section is positioned interior of both the rigid first half and the rigid second half; and retaining the rigid first half to the rigid second half about the pipe section.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a plan view illustration of a pipe covering apparatus, in accordance with a first exemplary embodiment of the present disclosure.

FIG. 2 is top view illustration of the second half of the pipe covering apparatus, in accordance with the first exemplary embodiment of the present disclosure.

FIG. 3 is a side view illustration of the second half of the pipe covering apparatus, in accordance with the first exemplary embodiment of the present disclosure.

FIG. 4 is a top view illustration of a pipe covering apparatus for an elbow, in accordance with the first exemplary embodiment of the present disclosure.

FIG. 5 is a side view illustration of the first half of the pipe covering apparatus, in accordance with the first exemplary embodiment of the present disclosure.

FIG. 6 is a side view illustration of the second half of the pipe covering apparatus, in accordance with the first exemplary embodiment of the present disclosure.

FIGS. 7A-7C are plan view illustrations of a pipe covering apparatus 10, in accordance with the first exemplary embodiment of the present disclosure.

FIG. 8 is a cross-sectional illustration of a pipe covering apparatus, in accordance with a second exemplary embodiment of the present disclosure.

FIG. 9 is a top view illustration of a first half of a pipe covering apparatus, in accordance with a third exemplary embodiment of the present disclosure.

FIG. 10 is a top view illustration of a second half of a pipe covering apparatus, in accordance with a third exemplary embodiment of the present disclosure.

FIG. 11 is a flowchart illustrating a method for constructing a pipe covering apparatus, in accordance with the first exemplary embodiment of the present disclosure.

FIG. 12 is a flowchart illustrating a method of covering a pipe section with a pipe covering apparatus, in accordance with the first exemplary embodiment of the present disclosure.

### DETAILED DESCRIPTION

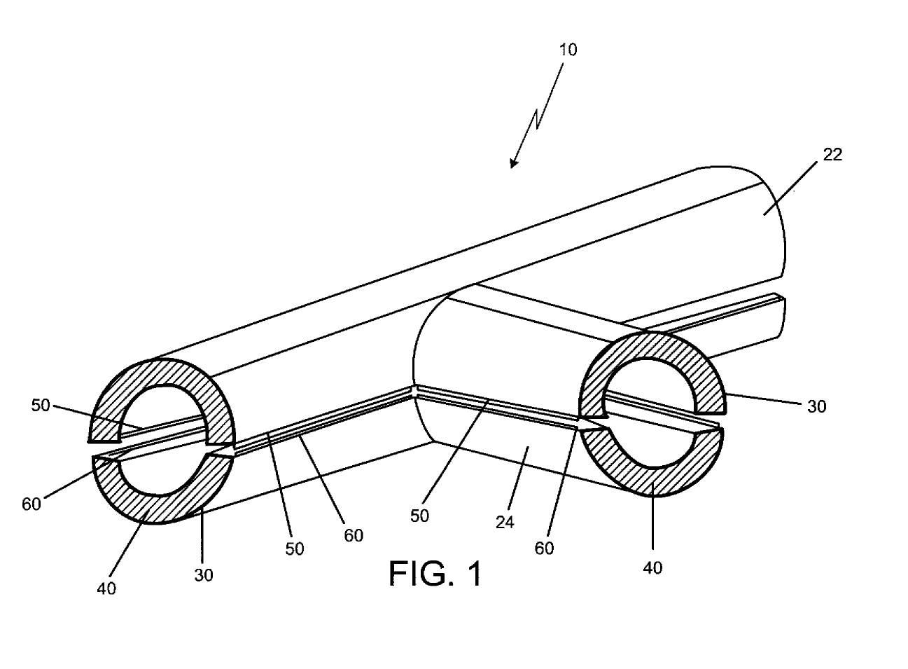

FIG. 1 is a plan view illustration of a pipe covering apparatus 10, in accordance with the first exemplary embodiment of the present disclosure. The pipe covering apparatus 10 has a first half 22 mateable with a second half 24 along a length of the pipe covering apparatus 10. Each of the first half 22 and second half 24 have a substantially rigid exterior shell 30 and a flexible insulated liner 40 positioned interior to the exterior shell 30. A plurality of male connecting elements 50 and a plurality of female connecting elements 60 are integral with each of the first half 22 and second half 24. The plurality of male connecting elements 50 and plurality of female connecting elements 60 on the first half 22 have comparable positions relative to the plurality of male connecting elements 50 and plurality of female connecting elements 60 on the second half 24. The plurality of male connecting elements 50 on the first half 22 may engage with the plurality of female connecting elements 60 on the second half 24.

The pipe covering apparatus 10 is shaped to cover a variety of pipes, pipe joints and other pipe features. This may include straight lengths of pipe, curved lengths of pipe, pipe elbows, pipe tees, pipe straight connector, such as a coupler, and any other pipe features used within any application that pipes are present in. In accordance with this disclosure, pipes may also include tubing, or any other similar structure, including pipes or tubes that are sized by trade size, schedule, an inner or outer diameter, wall thickness, or any combination thereof. The pipe covering apparatus 10 may provide an insulated covering for the pipe and/or pipe joint, which may retard heat loss with a pipe carrying a heated substance, and/or provide mechanical protection to a pipe. The pipe covering apparatus 10 may be used in any industry where pipes are present, such as the food processing industry, the biomedical industry and the pharmaceutical industry. The pipe covering apparatus 10 may be used with a pipe or pipe joint having any size and/or constructed from any type of material. Additionally, one size of a pipe covering apparatus 10 may be used with a variety of different sized pipes and pipe joints.

The pipe covering apparatus 10 includes a first half 22 and a second half 24 that are mateable along the length of the pipe covering apparatus 10. Generally, the length of the pipe covering apparatus 10 will be the portion of the pipe covering apparatus 10 that has the greatest length of material, and not a diameter cross-section of the pipe covering apparatus 10. In other words, the pipe covering apparatus 10 sandwiches around a pipe or pipe joint with the first half 22 on one planar side of the pipe or pipe joint and the second half 24 on an opposing planar side of the pipe or pipe joint. The exterior shell 30 may be constructured from a variety of materials, such as PVC or another substantially rigid material. The flexible insulated liner 40 may be affixed to an interior side of the exterior shell 30. The flexible insulated liner 40 may be glued, bonded or otherwise affixed in any known manner.

The pipe covering apparatus 10 may be placed over a pipe and/or pipe joint, pipe weld, or similar feature, and may enclose the pipe and/or pipe joint. This relationship allows for protection of not only a pipe, but also of a pipe joint and pipe weld. As one having ordinary skill in the art would recognize, the flexible insulated liner 40 may conform to the outer surface of the pipe and/or pipe joint, thereby abutting the pipe and/or pipe joint to provide efficient insulating of the pipe. Even when the pipe covering apparatus 10 is placed over a pipe and a pipe joint that has a larger outer diameter than the pipe, the pipe covering apparatus 10 may still provide successful insulating to the pipe and pipe joint through the conforming flexible insulating layer 40.

The first half 22 and second half 24 of the pipe covering apparatus 10 have identically located male connecting elements 50 and female connecting elements 60. In other words, the male connecting elements 50 on the first half 22 may be in an identical position to the male connecting elements 50 on the second half 24, and the female connecting elements 60 on the first half 22 may be in an identical position to the female connecting elements 60 on the second half 24. Identical locations of the male and female connecting elements 50, 60 of the first and second halves 22, 24, may also include identically sized male and female connecting elements 50, 60 for each of the first and second halves 22, 24.

The exterior shell 30 and the flexible insulated liner 40 are similarly shaped and positioned on the first half 22 and the second half 24. This allows the first and second halves 22, 24 to be interchangeable on either side of the pipe or pipe joint, which provides a more convenient installation than conventional pipe covers. An installer in the field can save time by not having to select a specific left or right half of the pipe covering apparatus 10, since both the first and second halves 22, 24 can be used on either side of a pipe or pipe joint interchangably. Once the pipe covering apparatus 10 is installed on a pipe and/or pipe joint, a sealing method may be used to allow the pipe covering apparatus 10 to withstand a washdown or any clean-in-place procedures that it may be subjected to. Furthermore, the pipe covering apparatus 10 may be constructed to meet NSF-61 and ASTM E-84 specifications.

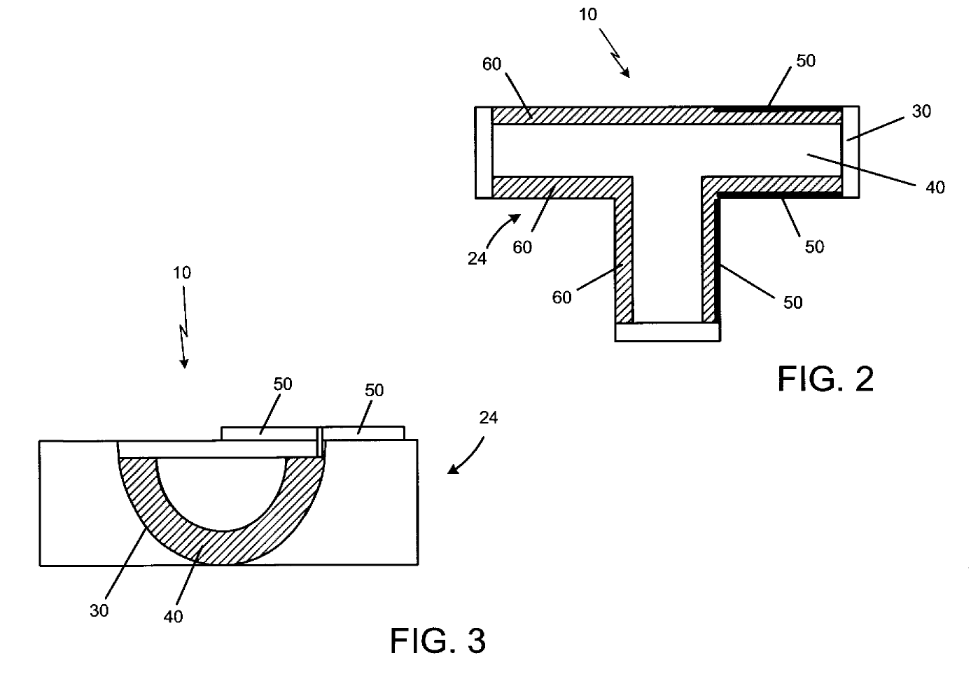

FIG. 2 is top view illustration of the second half 24 of the pipe covering apparatus 10, in accordance with the first exemplary embodiment of the present disclosure. FIG. 3 is side view illustration of the second half 24 of the pipe covering apparatus 10, in accordance with the first exemplary embodiment of the present disclosure. The male and female connection elements 50, 60 are integral with each of the first half 22 and second half 24, and may be formed through a molding process when the first and second halves 22, 24 are formed. The female connection elements 60 may receive or engage the male connection elements 50 to retain the first and second halves 22, 24 in stationary positions, with respect to each other. As can be seen, the male and female connection elements 50, 60 may be located in a variety of positions on the pipe covering apparatus 10. Specifically, the male and female connection elements 50, 60 are positioned to compliment each other, such that the male connection elements 50 may correspond to the female connection elements 60 of the same half (either the first or second half, 22, 24) when it is placed in the opposite configuration, as is illustrated in FIG. 1.

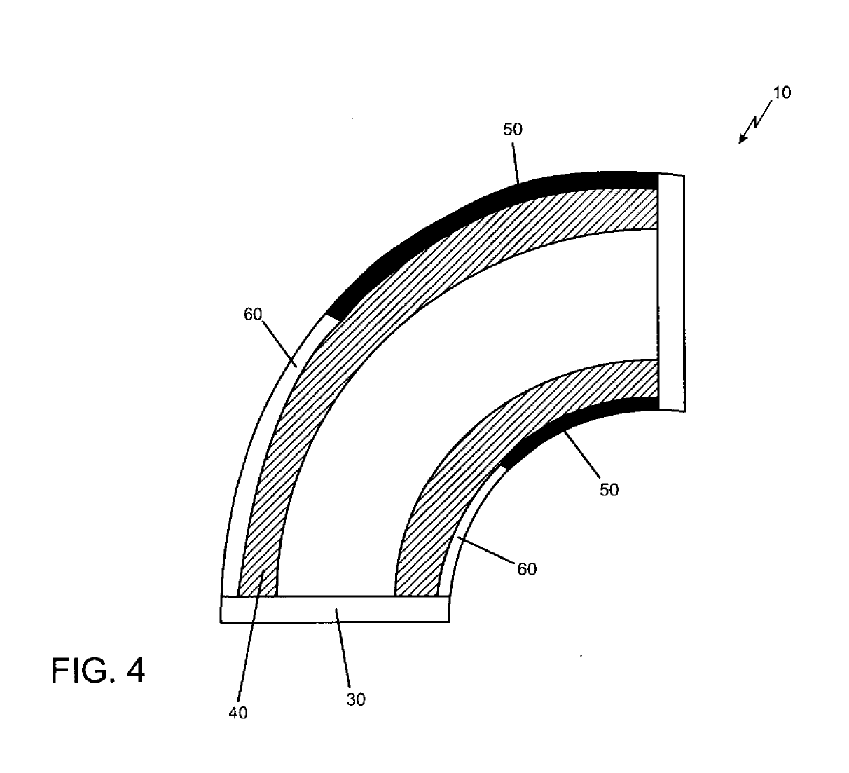

FIG. 4 is a top view illustration of a pipe covering apparatus 10 for an elbow, in accordance with the first exemplary embodiment of the present disclosure. The pipe covering apparatus 10 shown in FIG. 4 is substantially similar to the pipe covering apparatus 10 of FIGS. 1-3. However, the pipe covering apparatus 10 of FIG. 4 is sized to cover an elbow joint, whereas the pipe covering apparatus 10 of FIGS. 1-3 is sized to cover a tee joint. As can be seen in FIG. 4, the pipe covering apparatus 10 includes male connection elements 50 and female connection elements 60 that are located in corresponding locations, thereby allowing the pipe covering apparatus 10 to be used universally.

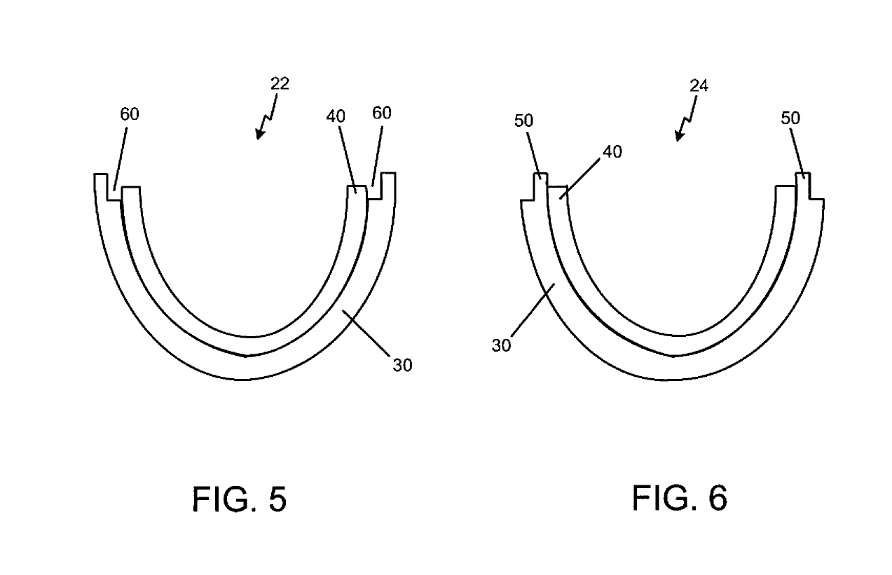

FIG. 5 is a side view illustration of the first half 22 of the pipe covering apparatus 10, in accordance with the first exemplary embodiment of the present disclosure and FIG. 6 is a side view illustration of the second half 24 of the pipe covering apparatus 10, in accordance with the first exemplary embodiment of the present disclosure. Each of the first half 22 and the second half 24 include an exterior shell 30 and a flexible insulated liner 40 positioned interior of the exterior shell 30. As is shown, the plurality of male connecting elements 50 of FIG. 6 further comprise a plurality of protruding tabs and the plurality of female connecting elements 60 of FIG. 5 further comprise a plurality of slots. Each of the protruding tabs or slots that form the male and female connecting elements, respectively, may be integrally formed with the exterior shell 30.

The plurality of male connecting elements 50 may fit within the plurality of female connecting elements 60 when the second half 24 is positioned engaged with the first half 22. In other words, when the second half 24 and the first half 22 are positioned about a pipe, pipe section or pipe fitting, the second half 24 may be positioned to engage with the first half 22, such that the male connecting elements 50 on each of the first and second halves 22, 24 (but only shown on the second half 24 in FIGS. 5 & 6) enter into the female connecting element 60 on each of the first and second halves 22, 24 (but only shown on the first half 22 in FIGS. 5 & 6). This configuration may provide for an interlocking fit between the first half 22 and the second half 24. The engaged or interlocked first half 22 and second half 24 may be retained once in this position with a retaining mechanism, such as a sealing tape, sealing adhesive, mechanical retaining mechanism, or other similar device.

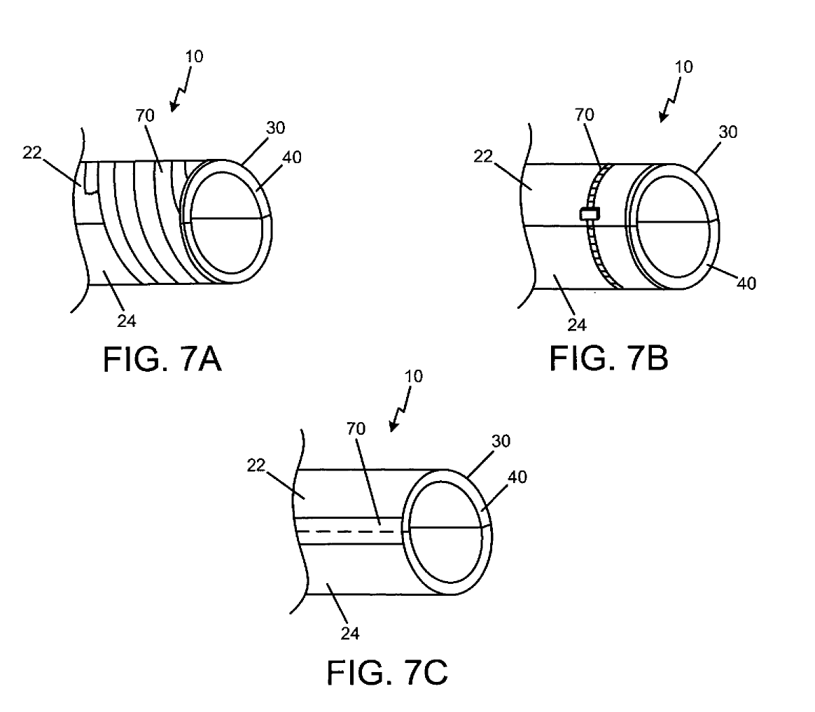

FIGS. 7A-7C are plan view illustrations of a pipe covering apparatus 10, in accordance with the first exemplary embodiment of the present disclosure. Each of FIGS. 7A-7C illustrate a retention element 70, which may include any type of retaining device or retaining system for retaining the first and second halves 22, 24 proximate to each other. For instance, the retention elements 70 may be used, individually or in combination with each other, once the first and second halves 22, 24 are installed about a pipe, pipe joint or other pipe section. The retention element 70 may keep the first and second halves 22, 24 in a substantially stationary position relative to each other, thereby preventing the first and second halves 22, 24 from moving, becoming separated, or otherwise being disrupted by any cleaning process on the pipe or pipe joint, or other contact of the first and second halves 22, 24.

Specifically, FIG. 7A illustrates the retention element 70 as a sealing tape, which is wound or wrapped around both the first and second halves 22, 24. This may include an adhesive tape or material, which is prevented from unraveling by an adhesive bond created between the tape and the exterior shell 30 of the first and second halves 22, 24. FIG. 7B illustrates the retention mechanism 70 as a pipe clamp or other mechanical fastener, which is placed around the first and second halves 22, 24 and tightened to retain them in place. FIG. 7C illustrates the retention mechanism 70 as a sealing tape or sealing material, which is applied to the joint formed between the first and second halves 22, 24 when they are engaged with each other. The sealing tape or sealing material may include any type of material, including compounds, which are applied to the seal and cured or otherwise dried. For example, this may include silicon based materials, or adhesive tapes. Any of the retention mechanism 70 may be permanent or removable, and may be applied to any portion of the pipe covering apparatus 10, or a pipe, pipe joint, or other pipe section.

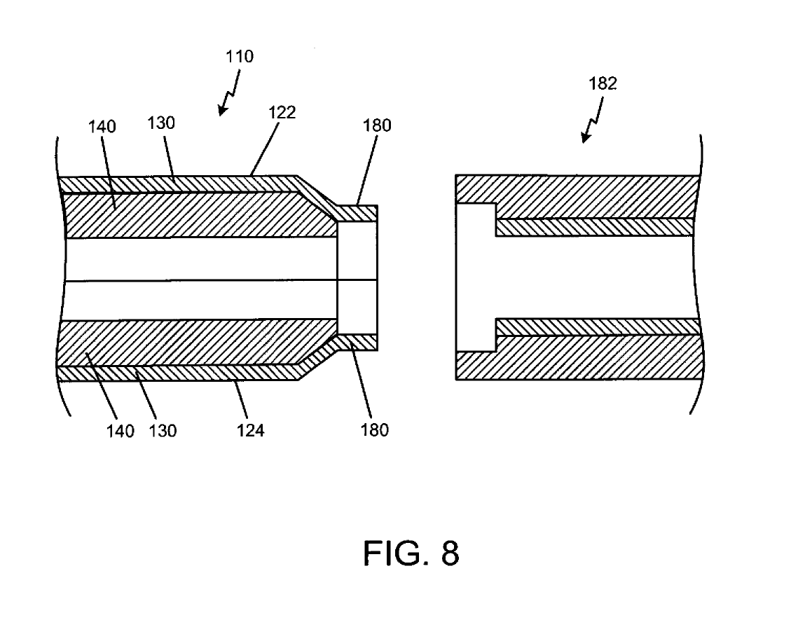

FIG. 8 is a cross-sectional illustration of a pipe covering apparatus 110, in accordance with a second exemplary embodiment of the present disclosure. The pipe covering apparatus 110 of the second exemplary embodiment is substantially similar to the pipe covering apparatus 10 of the first exemplary embodiment, and may include any of the features, structures, or functions that are discussed with respect to the first exemplary embodiment. As is shown in FIG. 8, the pipe covering apparatus 110 has a first half 122 mateable with a second half 124 along a length of the pipe covering apparatus 110. Each of the first half 122 and second half 124 have a to substantially rigid exterior shell 130 and a flexible insulated liner 140 positioned interior to the exterior shell 130.

Although not shown in FIG. 8, a plurality of male connecting elements and a plurality of female connecting elements are integral with each of the first half 122 and second half 124, as was disclosed with respect to the first exemplary embodiment. The plurality of male connecting elements and plurality of female connecting elements on the first half 122 have identical positions to the plurality of male connecting elements and plurality of female connecting elements on the second half 124. The plurality of male connecting elements on the first half 122 may engage with the plurality of female connecting elements on the second half 124.

The pipe covering apparatus 110 also includes a downsized portion 180 of each of the first half 122 and second half 124 of the pipe covering apparatus 110 positioned at an end of each of the first half 122 and second half 124 of the pipe covering apparatus 110. In FIG. 8, the downsized portion 180 is shown in relation to a secondary pipe fitting 182. The downsized portion 180 may include a section of the exterior shell 140, which has a smaller radius dimension than a middle portion, or other non-end portion of the pipe covering apparatus 110. This allows for the end of the pipe covering apparatus 110 to be inserted into the secondary pipe fitting 182 successfully, forming a joint therebetween. Of course, other designs may be included with the downsized portion 180, including any other size or dimension, all of which are considered within the scope of the present disclosure.

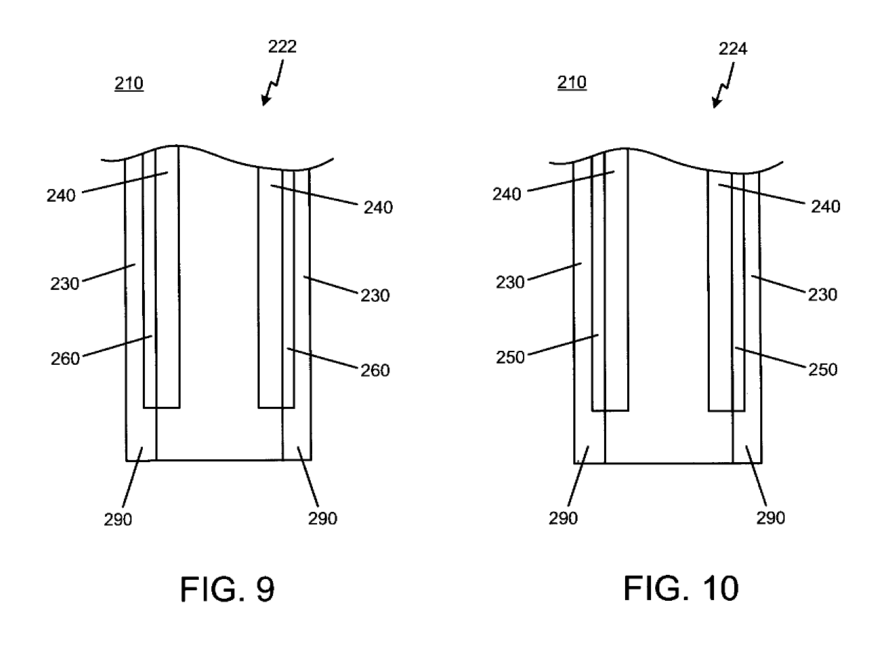

FIG. 9 is a top view illustration of a first half 222 of a pipe covering apparatus 210, in accordance with a third exemplary embodiment of the present disclosure and FIG. 10 is a top view illustration of a second half 224 of a pipe covering apparatus 210, in accordance with a third exemplary embodiment of the present disclosure. The pipe covering apparatus 210 of the third exemplary embodiment is substantially similar to the pipe covering apparatus 10, 110 of the first and second exemplary embodiments, and may include any of the features, structures, or functions that are discussed with respect to the first or second exemplary embodiments. As is shown in FIGS. 9 and 10, the first half 222 and second half 224 of the pipe covering apparatus 210 is shown, with the first half 222 shown in FIG. 9 and the second half 224 shown in FIG. 10.

Each of the first half 222 and second half 224 includes a substantially rigid exterior shell 230 and a flexible insulated liner 240 positioned interior to the exterior shell 230. A plurality of male connecting elements 250 and a plurality of female connecting elements 260 are integral with each of the first half 222 and second half 224, as was disclosed with respect to the first exemplary embodiment. However, for clarity of disclosure, the plurality of male connecting elements 250 are only shown in FIG. 10, and the plurality of female connecting elements 260 are only shown in FIG. 9. The plurality of male connecting elements 250 and plurality of female connecting elements 260 on the first half 222 have identical positions to the plurality of male connecting elements 250 and plurality of female connecting elements 260 on the second half 224. The plurality of male connecting elements 250 on the first half 222 may engage with the plurality of female connecting elements 260 on the second half 224.

Each of the first and second halves 222, 224 have an ending element 290 positioned on an end portion of each of the first half 222 and second half 224. The ending element 290 may include a larger structure of material that is integrally formed with the exterior shell 230 and provides for structural durability at an end of the first and second halves 222, 224. As can be seen, the ending element 290 may be positioned between the connecting elements 250, 260 and the ending edge of the first or second halves 222, 224, respectively. Although engagement of the male and female connecting elements 250, 260 may generally prevent lateral movement of the first half 222 with respect to the second half 224, the ending element 290 may ensure that the male and female connecting elements 250, 260 are sufficiently engaged. The ending element 290 may keep the ends of both the first and second halves 222, 224 substantially aligned.

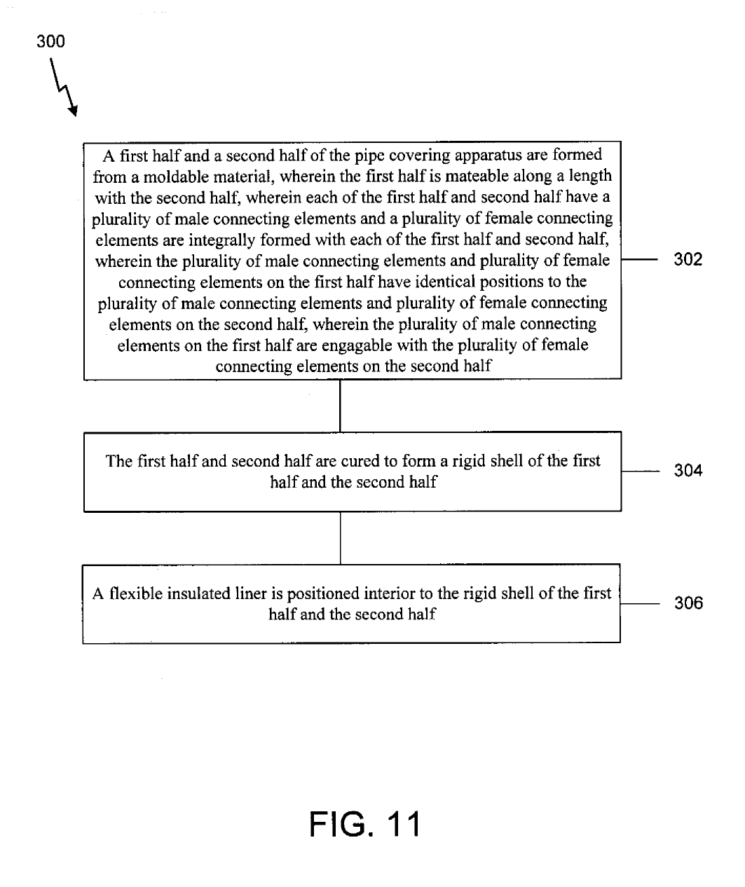

FIG. 11 is a flowchart 300 illustrating a method for constructing a pipe covering apparatus, in accordance with the first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 302, a first half and a second half of the pipe covering apparatus are formed from a moldable material, wherein the first half is mateable along a length with the second half, wherein each of the first half and second half have a plurality of male connecting elements and a plurality of female connecting elements are integrally formed with each of the first half and second half, wherein the plurality of male connecting elements and plurality of female connecting elements on the first half have identical positions to the plurality of male connecting elements and plurality of female connecting elements on the second half, wherein the plurality of male connecting elements on the first half are engagable with the plurality of female connecting elements on the second half. The first half and second half are cured to form a rigid shell of the first half and the second half (block 304). A flexible insulated liner is positioned interior to the rigid shell of the first half and the second half (block 306). Any additional number of steps or variations thereof may be included, including any of functions and implementation of structure discussed with regards to FIGS. 1-10.

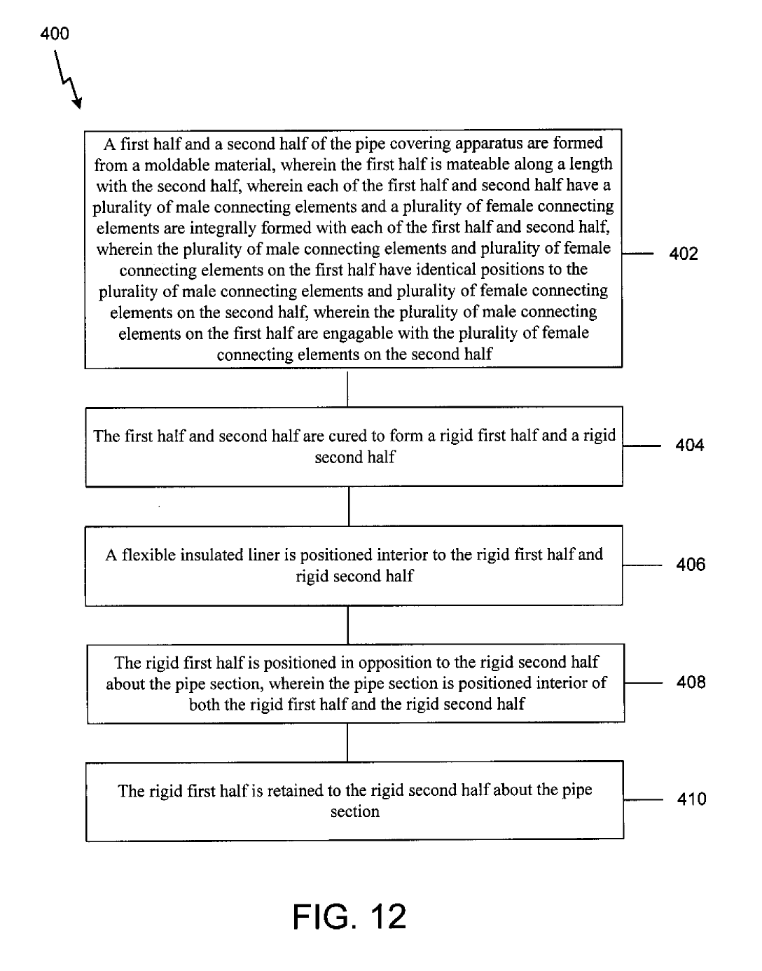

FIG. 12 is a flowchart 400 illustrating a method of covering a pipe section with a pipe covering apparatus, in accordance with the first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

At block 402, a first half and a second half of the pipe covering apparatus are formed from a moldable material, wherein the first half is mateable along a length with the second half, wherein each of the first half and second half have a plurality of male connecting elements and a plurality of female connecting elements are integrally formed with each of the first half and second half, wherein the plurality of male connecting elements and plurality of female connecting elements on the first half have identical positions to the plurality of male connecting elements and plurality of female connecting elements on the second half, wherein the plurality of male connecting elements on the first half are engagable with the plurality of female connecting elements on the second half. The first half and second half are cured to form a rigid first half and a rigid second half (block 404). A flexible insulated liner is positioned interior to the rigid first half and rigid second half (block 406). The rigid first half is positioned in opposition to the rigid second half about the pipe section, wherein the pipe section is positioned interior of both the rigid first half and the rigid second half (block 408). The rigid first half is retained to the rigid second half about the pipe section (block 410). Any additional number of steps or variations thereof may be included, including any of functions and implementation of structure discussed with regards to FIGS. 1-10.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A pipe covering apparatus comprising:
a first half of the pipe covering apparatus mateable along a length with a second half of the pipe covering apparatus, each of the first half and second half having a substantially rigid exterior shell and a flexible insulated liner positioned interior to the exterior shell; and
a plurality of male connecting elements and a plurality of female connecting elements integral with each of the first half and second half, the plurality of male connecting elements and plurality of female connecting elements on the first half having identical positions to the plurality of male connecting elements and plurality of female connecting elements on the second half, wherein the plurality of male connecting elements on the first half engages with the plurality of female connecting elements on the second half.

2. The pipe covering apparatus of claim 1, wherein the first half and second half of the pipe covering apparatus is sized to fit at least one of a pipe elbow, a pipe tee and a pipe straight connector.

3. The pipe covering apparatus of claim 1, further comprising a downsized portion of each of the first half and second half of the pipe covering apparatus positioned at an end of each of the first half and second half of the pipe covering apparatus.

4. The pipe covering apparatus of claim 1, further comprising an ending element positioned on each of the first half and second half of the pipe covering apparatus.

5. The pipe covering apparatus of claim 4, wherein for each of the first half and second half of the pipe covering apparatus, the ending element is positioned between an ending edge of the pipe covering apparatus and the plurality of male connecting elements and a plurality of female connecting elements, respectively.

6. The pipe covering apparatus of claim 1, wherein the plurality of male connecting elements further comprise a plurality of protruding tabs and the plurality of female connecting elements further comprise a plurality of slots, wherein the plurality of protruding tabs are sized to fit within the plurality of slots.

7. The pipe covering apparatus of claim 1, wherein the plurality of male connecting elements and the plurality of female connecting elements are formed integral with each of the first half of the pipe covering apparatus and the second half of the pipe covering apparatus.

8. The pipe covering apparatus of claim 1, wherein the plurality of male connecting elements and plurality of female connecting elements on the first half having identical sizes to the plurality of male connecting elements and plurality of female connecting elements on the second half.

9. The pipe covering apparatus of claim 1, further comprising a retention element in communication with each of the first half and the second half of the pipe covering apparatus, wherein the retention element retains the first half in a substantially stationary position relative to the second half.

10. A method for constructing a pipe covering apparatus, the method comprising the steps of:
forming a first half and a second half of the pipe covering apparatus from a moldable material, wherein the first half is mateable along a length with the second half, wherein each of the first half and second half have a plurality of male connecting elements and a plurality of female connecting elements integrally formed with each of the first half and second half, wherein the plurality of male connecting elements and plurality of female connecting elements on the first half having identical positions to the plurality of male connecting elements and plurality of female connecting elements on the second half, wherein the plurality of male connecting elements on the first half are engagable with the plurality of female connecting elements on the second half;
curing the first half and second half to form a rigid shell of the first half and the second half; and
positioning a flexible insulated liner interior to the rigid shell of the first half and the second half.

11. The method of claim 10, further comprising the step of sizing the first half and a second half of the pipe covering apparatus to fit at least one of a pipe elbow, a pipe tee and a pipe straight connector.

12. The method of claim 10, further comprising the step of sizing an end portion of each of the first half and second half of the pipe covering apparatus to have a smaller radius than a middle portion of each of the first half and second half of the pipe covering apparatus.

13. The method of claim 10, further comprising the steps of:
forming the plurality of male connecting elements as a plurality of protruding tabs;
forming the plurality of female connecting elements as a plurality of slots; and
sizing the plurality of protruding tabs to fit within the plurality of slots.

14. The method of claim 10, wherein the plurality of male connecting elements and plurality of female connecting elements on the first half having identical sizes to the plurality of male connecting elements and plurality of female connecting elements on the second half.

15. The method of claim 10, further comprising the step of retaining the first half and the second half of the pipe covering apparatus in a substantially stationary position relative to each other.

16. The method of claim 15, wherein the step of retaining the first half and the second half of the pipe covering apparatus in a substantially stationary position relative to each other further comprises sealing a seam formed between the first half and the second half.

17. A method of covering a pipe section with a pipe covering apparatus, the method comprising the steps of:
forming a first half and a second half of the pipe covering apparatus from a moldable material, wherein the first half is mateable along a length with the second half, wherein each of the first half and second half have a plurality of male connecting elements and a plurality of female connecting elements integrally formed with each of the first half and second half, wherein the plurality of male connecting elements and plurality of female connecting elements on the first half having identical positions to the plurality of male connecting elements and plurality of female connecting elements on the second half, wherein the plurality of male connecting elements on the first half are engagable with the plurality of female connecting elements on the second half;
curing the first half and second half to form a rigid first half and a rigid second half;
positioning a flexible insulated liner interior to the rigid first half and rigid second half;
positioning the rigid first half in opposition to the rigid second half about the pipe section, wherein the pipe section is positioned interior of both the rigid first half and the rigid second half; and
retaining the rigid first half to the rigid second half about the pipe section.

18. The method of claim 17, wherein the pipe section further comprises at least one of a pipe elbow, a pipe tee and a pipe straight connector.

19. The method of claim 17, wherein the step of retaining the rigid first half to the rigid second half about the pipe section further comprises:
engaging the plurality of male connecting elements on the rigid first half with the plurality of female connecting elements on the rigid second half; and
engaging the plurality of male connecting elements on the rigid second half with the plurality of female connecting elements on the rigid first half.

20. The method of claim 17, wherein the step of retaining the rigid first half to the rigid second half about the pipe section further comprises sealing a seam formed between the rigid first half and the rigid second half.
